(19) United States
(12) Patent Application Publication
(10) Pub. No.: US 2018/0291575 A1
(43) Pub. Date: Oct. 11, 2018

(54) System for Emergency Vehicle Communication and Computer Control

(71) Applicants: George S. Roe, JR., Jacksonville, FL (US); Henry W. Price, JR., Jacksonville, FL (US); Barrett E. Miller, Saint Augustine, FL (US)

(72) Inventors: George S. Roe, JR., Jacksonville, FL (US); Henry W. Price, JR., Jacksonville, FL (US); Barrett E. Miller, Saint Augustine, FL (US)

(21) Appl. No.: 15/485,121

(22) Filed: Apr. 11, 2017

(51) Int. Cl. E01F 13/12; B66B 1/28; B60W 30/18; E01F 9/30; B60W 10/06

(52) U.S. Cl. CPC E01F 13/12; B66B 1/285; B60W 2750/308; E01F 9/30; B60W 10/06; B60W 30/1819

(57) ABSTRACT

A system for targeting, remotely accessing, and assuming control of a specific vehicles computer with the intent to disrupt both accelerator and/or transmission functions. This includes the ability for emergency responders to target a specific vehicle to establish wireless communication with the vehicles control module to gain access to vehicle systems. This further includes the transfer of information between the emergency responder and the specific vehicle to include make, model, VIN, interrupt code, etc. If the specific vehicle is deemed in violation of highway safety regulations, a manufacturer pre-programmed interrupt code may be used to assume control of a limited set of the vehicle computer functions inclusive of acceleration and transmission. In the event an interrupt code is received by the specific vehicle, the vehicles computer will automatically lockout driver input commands from the accelerator and/or transmission gear shift, cause the transmission to shift to neutral and/or cause the deceleration of the vehicle, and maintain this state until the vehicle safely comes to a stop and a reset code is entered. In this way the engine is left running to allow the driver of the specific vehicle to maintain control of the vehicles critical systems including but not limited to hydraulics, power steering, stability control etc.

### CROSS-REFERENCES

None

### GOVERNMENT RIGHTS

None

### OTHER PUBLICATIONS

None

### BACKGROUND OF INVENTION

### Field of Invention

The technology described in the disclosed patent document relates generally to the field of emergency vehicle communications.

### DISCUSSION

### Purpose of the Invention

The purpose of the disclosed invention is to provide a means for the remote selective controlled stopping of a vehicle by the authorities using radio frequency communications and computer controlled transmission disengaging functions.

### Description of the Prior Art

In the case of a vehicle being pursued by a police cruiser, traditional means for slowing down or stopping a runaway vehicle consist of barricades, spike strips, choke points, or blockades. In particular, barricades and blockades present immediate danger to police personal involved in either setting up the barricades and/or the blockade itself which usually involves police assets to block the path of oncoming travel. The danger lies in a pursued vehicle that does not stop, either sending barricade debris in hazardous directions, or physically ramming police asset blockade(s) endangering officers and causing monetary damage to said police assets. Spike strips have been used to eliminate these dangers by puncturing the tires of the pursued vehicle in an effort to either slow the vehicle down or make it difficult for the pursued vehicle to continue driving and thereby escape. Spike strips have inherent dangers as in a high speed chase wherein loss of tire pressure at high velocity could cause the vehicle to become uncontrollable, potentially causing the vehicle to flip. Further, these strips in no way guarantee that the pursued vehicle will stop.

All of these possible means to slow down or disable a pursued vehicle inherently involve directing the pursued vehicle to a specific location where these means can be setup ahead of time. Further, they involve a multitude of officers to coordinate actions to direct the pursued vehicle as well as to isolate it from other bystander(s) traffic. What is needed is a means for a single officer to be able to remotely disable a specific vehicle safely, causing the vehicle to slow down to a stop while allowing the pursued vehicle to maintain control over driving conditions such as traction control, brakes, power steering, etc. In this way a pursued vehicle could be safely stopped without endangering the lives of officers or other drivers on or off the roadway and without the use of a multitude of officers.

### SUMMARY OF INVENTION

In accordance with the teachings of this invention as embodied and described herein, systems are provided for a means for the remote selective controlled stopping of a vehicle by the authorities or emergency responders using radio frequency communications and computer controlled transmission disengaging functions. The present invention discloses a remote sensing and actuation system used to allow a pursuing (emergency responder) vehicle to wirelessly communicate with a pursued (target) vehicle to remotely lock-out certain functions of the pursued vehicle, namely the accelerator and/or transmission gear shift, while simultaneously and automatically causing the transmission to shift to neutral so as to cause the vehicle to come to a complete and safe stop without endangering the driver or other automobiles on or off the roadway. In the specific case of all electric autonomous vehicles this is achieved strictly through accelerator control.

In the event that the pursuing vehicle (emergency responder) determines that a vehicle is in violation of highway safety laws, the officer driving the pursuing vehicle may pull up behind the pursued vehicle and with a front mounted camera align the pursuing vehicle within a Target zone of the dashboard screen located in the dashboard of the pursuing vehicle (a police cruiser for example). Once the vehicle is aligned the officer may press a button on the screen to “Lock-on” to that vehicle, causing the associated computer to transmit a signal to the target vehicle requesting information and access to the pursed vehicles computer. Upon recognition of the transmitted signal as a standard police code, the pursued vehicle will transmit the requested information back to the pursuing vehicle (inclusive of vehicle type, make, model, VIN, interrupter code, etc). If the officer wishes to communicate with the driver of the target vehicle he/she can do so through a different on-screen button assuming the pursued vehicle is so equipped with an audio system. If the officer deems the vehicle in an unsafe condition he/she can select an additional button to transmit an interrupt code to the pursued vehicle.

The interrupt code is a unique pre-programmed code provided by the manufacturer of the vehicle (different for each make, model, type, and year) that once received by the pursued vehicles circuitry and passed on to the Powertrain control module (PCM) and the transmission control unit (TCU) allows a pursuing officer to cause the computer controlled transmission of the pursued vehicle to be automatically shifted into neutral. Further, the interrupt code will instruct the pursued vehicles computer to disable the vehicles accelerator and lock-out any driver input from these two systems. Without shutting the engine off, this allows the driver to maintain safe control over vehicle functions that affect safe driving conditions such as hydraulics, power steering, electronic stability control, etc.

Modern electronic transmissions combine several control modules into a single piece of hardware called the Power-train Control Module (PCM). The PCM may contain the transmission control unit (TCU), the engine control unit (ECU), and the body control unit (BCM) among others. In a high speed/high engine RPM situation, the PCM will cause the engine to rev down into idle. Once the engine begins decreasing in rpm, the PCM will then disengage the electronic transmission and cause it to shift into neutral. This action neither shuts the engine off, allowing the driver to maintain control over vehicular systems (power steering, hydraulic brakes, etc.), nor causes the downshifting of the transmission to slow the vehicle down and preventing damage to the vehicle or creating an unsafe driving condition. Under these parameters the vehicle will slow down either through braking or eventually coming to rest without allowing the driver to continually rev the engine potentially causing damage. The PCM will remain in this state until the velocity of the vehicle is zero and the engine is turned off and the PCM reset through a manufacturer specific algorithm entered by the driver. This algorithm may be similar to a series of key on/key off cycles coupled with the depressing of the accelerator for example. Further the control module in communication with the PCM will not allow power to the engine to be turned off as in the case of turning the key to the off position thus preventing an attempted engine restart or shutdown while at high speed.

Additional functions available to the emergency responder include two-way verbal communication over the pre-existing audio circuit of the pursued vehicle, notification of the state of the vehicle on the instrument cluster, and the flashing of the existing original equipment manufacturer (OEM) lights to alert other drivers of the situation.

The present invention also has the capability to communicate wirelessly with the user via pre-existing OEM BLUETOOTH®, WI-FI®, or the like. This functionality will allow the user to pursuing vehicle to communicate over a variety of frequencies.

By utilizing the current invention disclosed herein, the limitations of the prior art may be overcome.

### BRIEF DESCRIPTION OF DRAWINGS

FIG. 1 is an example of a police cruiser dash board showing a vehicle target lock in the display.

FIG. 2 is an example of a police radar gun style hand-held unit showing a vehicle target lock in the display.

FIG. 3 is a flowchart diagram illustrating interaction steps between a pursuing vehicle and a pursued vehicle.

FIG. 4 is a circuit diagram illustrating one embodiment of the pursuing vehicle circuitry.

FIG. 5 is a circuit diagram illustrating one embodiment of the vehicle communication interface.

FIG. 6 is a circuit diagram illustrating one embodiment of the pursued vehicle circuitry.

### DETAILED DESCRIPTION OF THE INVENTION

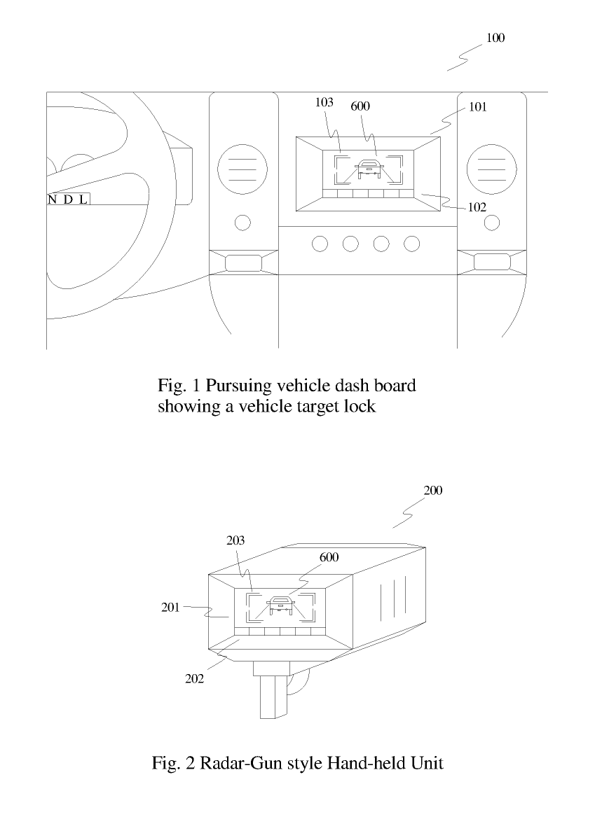

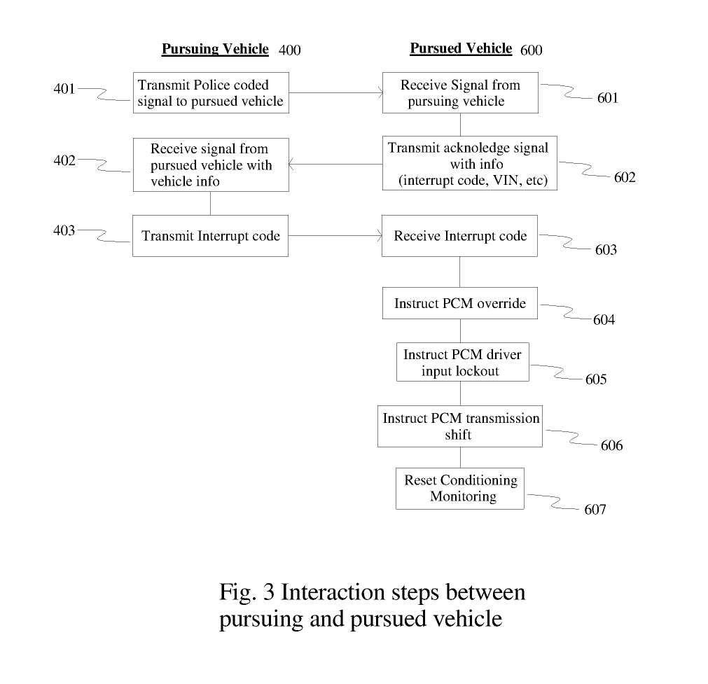

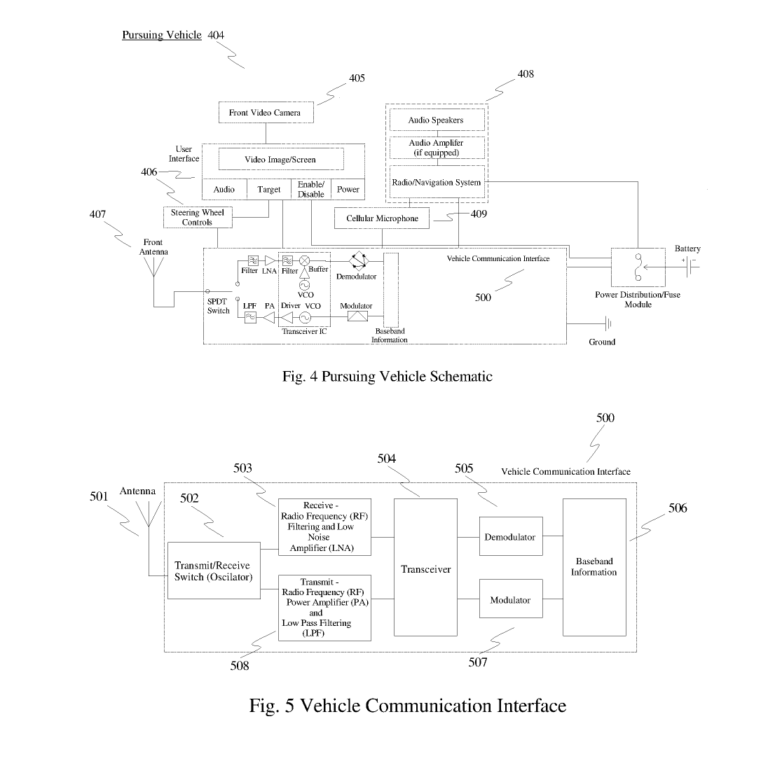

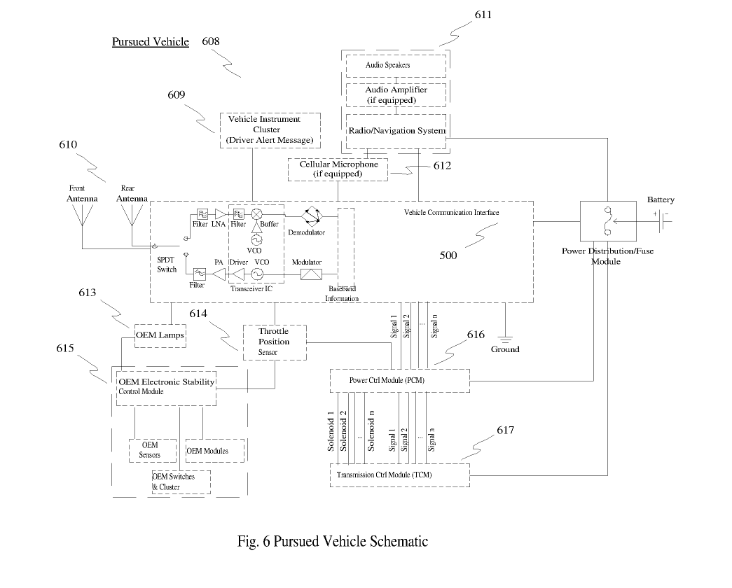

Referring now to the drawings, and more particularly FIG. 1, the present invention, as shown in one embodiment, is a view of a police vehicle dash board 100 mounted display screen 101 and display push buttons 102 (either mechanical, digital, touchscreen, steering wheel mounted, electrical via a laptop button, or the like) to actuate control commands of the connected controller (circuitry of FIGS. 4 and 5). Within this screen 101 is a view of a pursued vehicle (600 from FIG. 3) from a forward mounted camera (405 from FIG. 4) (not shown in FIG. 1) located somewhere on the pursuing vehicle including but not limited to the front bumper, top mounting near the roof mounted lights, or a dash mounted camera (not shown). The display screen 101 has a pre-determined “Target zone”103 within which the pursued vehicle is aligned by the pursuing officer through the steering of the pursuing vehicle (police cruiser, or the like). The display buttons 102 are those that an officer would use to initiate and function a wireless communication with and between a pursued vehicle(s).

FIG. 2 shows a second embodiment of the present invention as a hand-held unit 200 in the style of a police radar style “gun” equivalent with, and without limitation, an LCD target screen and similar function to that in the police vehicles hardwired system. The hand-held 200 version of the present invention also contains a display screen 201 and mechanical or digital push buttons 202 to actuate control commands of the hand-held unit 200 controller in a similar way as a pursing vehicle would. The operation of the hand-held unit is analogous to the dash mounted system of FIG. 1 and similarly contains a “Target zone” 203, for the alignment and tracking of a pursued vehicle 600 (from FIG. 3). In this way an officer on a motorcycle or standing on the side of the road may disable a specific vehicle in a similar manner.

In the preferred embodiment, an officer pursuing a vehicle in a pursuing vehicle 400 (of FIG. 3) would either, through the dash mounted screen 101 (of FIG. 1) or a pre-existing wired laptop, pull up behind the pursued vehicle to a distance of within 300-600 ft and via a front mounted camera (405 from FIG. 4) center the pursued vehicle on screen in the “Target zone” 103. Once the pursued (or target) vehicle 600 is centered in the police vehicles display screens “Target zone” 103, the officer would depress a push button to “Lock-On” the vehicle. The “Locking-On” of the vehicle refers to the preferred communication target in the field of view of both the display camera as well as the directed antenna(s).

FIG. 3 shows a flow diagram of the steps an emergency responder would take to initiate communication with and between a pursuing 400 and pursued 600 vehicle. Once a police officer puts the target vehicle in the “target zone” of the display, the action of pressing the “Lock-On” button causes the pursuing vehicle 400 to wirelessly transmit 401 a coded signal to the pursued vehicle 600 identifying it as a police vehicle or emergency responder. This signal is without limitation in the shortwave radio frequency (Rf) band, in a narrow field of view toward the vehicle in the “target zone. The transmitted signal 401 sent from the pursuing vehicle 400 contains a standard code assigned to police departments identifying them as an emergency responder. The transmitted signal 401 is then received by the pursued vehicle's antenna 601 (610 of FIG. 6) and transferred to its circuitry (608 of FIG. 6). The pursued vehicle circuitry 608 will then process the signal as a standard police emergency responder signal with an authorization code to allow access to the target vehicles computers. Upon verifying the police code received with that of an on-board stored series of emergency vehicle codes as registered in the National Crime Information Center (NCIC) and the National Vehicle Tracking Database (NVTD), the target vehicles onboard circuitry will transmit a return signal 602 back to the pursuing vehicle 402 identifying the vehicle with factory preprogrammed information about the vehicle (vehicle type, make, model, VIN, interrupter code, etc.) and granting full accesses to the target vehicle control systems. This return information allows the pursuing vehicle 400 to both identify and monitor various aspects of the pursued vehicle 600 such as speed, as well as communication with the driver of the pursued vehicle 600 (over a secure frequency) through the stereo/speaker system of the vehicle. In the event of a failed or incomplete communication attempt with the pursued vehicle 600 due to a rejected or unacknowledged emergency responder code, the pursuing vehicle 400 can wirelessly connect to police HQ to query the interrupt code (from NCIC database) with information available to the police officer while driving (such as VIN, make, model, interrupt code, license plate number, etc.).

The pursuing vehicle signal 401 could potentially activate a multitude of vehicles in its line of site as each line of sight vehicle receives the standard police code and transmits a return signal back to the pursuing vehicle. Each vehicle in line of sight will attempt to communicate wirelessly with the pursuing vehicle 400. The pursuing vehicle 400 will identify the strongest return signal strength 602 from the multitude of vehicles in the direction of the on screen “target zone” 103. This is achieved through the use of a single antenna, or a plurality of antennas located on the police vehicle in various locations, including but not limited to the front, rear, or top of the vehicle. Once the strongest signal 602 is received by the pursuing vehicle 402 and correlated directionally with the pursued vehicle 600 in the “Target zone” (103 of FIG. 1), the pursuing vehicle 400 circuitry (404 of FIG. 4) will filter out all other signals and digitally lock on to that signal 602.

After a line of communication has been established, the officer in the pursuing vehicle 400 may track the vehicle from a safe distance and no longer needs to maintain a 300 ft distance behind the pursued vehicle 600 as it is now “Locked”.

In the event that the pursuing vehicle 400 determines that the pursued vehicle 600 is in violation of highway safety laws, or in the case of a run-away vehicle or a high speed chase, the officer may also cause the pursued vehicles transmission to disengage and automatically shift to neutral. This is achieved via the officer pressing a “Disable” button on the dash, screen, or steering wheel (102 from FIG. 1), of the pursuing vehicle 400 after a lock has been established causing the pursuing vehicles circuitry (404 of FIG. 4) to transmit the received interrupt code 403 to the pursued vehicle 600. Upon receiving the interrupt code 603, the pursued vehicle's circuitry (608 from FIG. 6) instructs the power control module (PCM) to override 604 and lockout 605 a limited set of driver input commands, most specifically accelerator and/or transmission gear shift inputs but without shutting the engine off. In this way the engine would still be running, providing power and hydraulics (hydraulic brakes, power steering, traction control, and other safety systems) to the vehicle so that the pursued driver may maintain control over the vehicles' braking and steering functions but can neither accelerate, nor change gears. The pursued vehicles circuitry (608 from FIG. 6) then instructs the PCM and transmission control module (TCM) to shift into neutral 606. Further the transmission of the pursued vehicle 600 will remain in neutral until a speed of zero is reached, the transmission is automatically shifted into park, and the engine turned off. At this point the pursued vehicle circuitry (608 of FIG. 6) enters a reset monitoring mode 607 whereby it waits for the vehicle to come to a complete stop and for the driver input of the override commanded reset to be entered. To reset the system a manufacturer specific reset algorithm must be entered into the controller. This may be achieved in a variety of ways such as (for example) turning the engine off, turning the key to the on position, pumping the brake two times and then restarting the engine.

Referring now to FIGS. 4 and 5, FIG. 4 discloses one embodiment of the pursuing vehicles circuitry 404 in which a pursuing vehicle lines up a pursued vehicle in the “Target zone” of the user interface 406 via a front mounted camera 405. The user interface 406 houses the video image screen and push buttons as well as incorporating any push buttons that may be mounted on the steering column. Upon actuation of said push buttons 406 the connected vehicle communication interface 500 will generate an RF signal containing identifying emergency responder code information and transmit said signal to the front antenna 407. The front antenna 407 will then receive a return signal and pass said signal on to the vehicle communication interface of FIG. 5. From FIG. 5, this signal will pass through a Single Pole Double Throw (SPDT) switch, or an oscillator passing the signal on to the receive radio frequency filtering to eliminate unwanted frequencies, and low noise amplifier circuit 503. The filter and amplification circuit 503 will pass the conditioned signal on to a transceiver 504 and then on to a demodulator 505 where the signal is converted from Radio Frequency (RF) to Intermediate Frequency (IF) which can be handled by a typical electrical circuit before ending in the baseband information 506 circuit where all the data is then dispersed to the Vehicle Control Module.

For the next transmission the appropriate data is generated by the Vehicle Control Module and is brought to the baseband information circuit 506 and passed through a modulator 507 to encode the signal. From there it follows a similar path as with the received signal passing through the transceiver 504 where the signal is converted from IF to RF, at the desired RF frequency. Once the RF signal is generated in the transceiver, it is then conditioned in the filter and amplifier circuit 508 and back to the oscillator switch 502 for transmission by the antenna 501. In this way an emergency responder may send and receive signals to and from a pursued vehicle to track, communicate and disable said pursued vehicle. Returning to FIG. 4, said emergency responder may communicate with the drive of the pursued vehicle through the pre-existing audio circuit 408 of the vehicle inclusive of any cellular microphones 409 that may be present.

FIG. 6 discloses one embodiment of the pursued vehicles circuitry 608 in which a pursuing vehicle transmits a signal that is received by the pursued vehicles antenna 610. Then in a similar fashion to that of the pursuing vehicles circuitry, the signal is then passed to the vehicle communication interface 500 where signals are filtered, amplified, conditioned, and then re-transmitted again through the antenna 610. In addition to handling inter-vehicle communications, the vehicle communications interface also communicates internally with the vehicle instrument cluster 609 to alert the drive as well as coordinate communication within the vehicle through the pre-existing audio circuitry 611 and any cellular microphones 612 present. In the event an interrupt code is received by the circuitry 608, the vehicle communication interface 500 will communicate the appropriate command codes to the PCM 616 & TCM 617 to affect the transmission gear shift, reduction of speed, and lockout of user input for those systems. Additionally the vehicle communication interface 500 will operate the flashing of the OEM lamps 613 to alert others drivers of the condition, as well as take over control of the electronic stability control 615 of the vehicle. These functions are monitored through the throttle position sensor 614.

The various embodiments of the present invention as shown in FIGS. 1-6 may be arranged and designed in a wide variety of different configurations that fall within the scope of the present invention, and may be applied to any type of system involving the remote communication and actuation of a pursued vehicles transmission by emergency responders in an effort to safely reduced the speed of, and temporarily disable a pursued vehicle in a safe manner.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

The invention claimed is:

1. A remotely operated transmission control apparatus having, in combination, a means for selecting a specific vehicle on a roadway; means also responsive to the last-named means for transmitting and receiving periodic radio signals to and from said specific vehicle; means for locking onto and communicating with only radio signals of said specific vehicle; means for transmitting and receiving data to and from said specific vehicle containing vehicle identification code information; means for assuming computer control of accelerator and/or transmission gear shifting functions of said specific vehicle; means for locking out specific driver input commands of said specific vehicle; means for causing said specific vehicle transmission to shift to neutral without shutting off the engine; and means for initiating two-way audio communication with the driver of said specific vehicle.

2. Apparatus as claimed in claim 1 and in which said means further includes a means for receiving, filtering, amplifying, and demodulating said received periodic radio signal(s) to and from said specific vehicle.

3. Apparatus as claimed in claim 1 and in which said means for causing said specific vehicle to decelerate to a stop in the case of an all electric vehicle.

4. Apparatus as claimed in claim 1 and in which there is provided a means for modulating, filtering, amplifying, and transmitting said periodic radio signal(s); means for displaying a locked-on condition in said specific vehicle; and means for flashing said specific vehicles external lights once communication with said specific vehicle is established.

5. A remotely operated transmission control apparatus having, in combination, a means for selecting a specific vehicle on a roadway; means also responsive to the last-named means for transmitting and receiving periodic radio signals to and from said specific vehicle; means for locking onto and communicating with only return radio signals of said specific vehicle; means for transmitting and receiving data to and from said specific vehicle containing vehicle identification code information; means for assuming computer control of accelerator and/or transmission gear shifting functions of said specific vehicle; means for locking out specific driver input commands of said specific vehicle; means for causing said specific vehicle transmission to shift to neutral without shutting off the engine; means for causing said specific vehicle to decelerate to a stop in the case of an all electric vehicle; means for initiating two-way audio communication with the driver of said specific vehicle; means for receiving, filtering, amplifying, and demodulating said received periodic radio signal to and from said specific vehicle; means for modulating, filtering, amplifying, and transmitting said periodic radio signal; means for displaying a locked-on condition in said specific vehicle; and means for flashing specific vehicles external lights once communication with said specific vehicle is established.

6. A method of remotely accessing a specific vehicles computer via an emergency responder or pursuing vehicle through periodic radio signals to communicate with the driver of said specific vehicle and remotely assume computer control of accelerator and/or transmission gear shifting functions, that comprises, a pursuing vehicle initiating said periodic radio signal communication with said specific vehicle; followed by data transfer from said specific vehicle of vehicle identification information; communication with the driver of said specific vehicle; followed by the transmission by said pursuing vehicle of a specific vehicle interrupt code allowing access to said specific vehicles computer system; followed by remote assumption of computer control of accelerator and/or transmission gear shifting functions of said specific vehicle; then locking out said specific vehicles driver input commands over accelerator and/or transmission function; followed by the remote shifting of said specific vehicles transmission to neutral or decelerating said specific vehicle to a stop; and maintaining a monitoring state of the acceleration and/or transmission systems until a speed of zero and a reset condition is received.

7. The method of claim 6 wherein the transmission and reception of said periodic radio signals occurs through the pre-existing antenna of both said pursuing vehicle and said specific vehicle.

8. The method of claim 6 wherein the means for transmitting said radio signals, receiving said radio signals, and assuming computer control of said specific vehicle is factory installed by the vehicle manufacturer.

9. The method of claim 6 wherein upon receipt of said interrupt code by said specific vehicle, said specific vehicles computer flashes said specific vehicles existing external lights.

10. The method of claim 6 wherein upon receipt of said interrupt code by said specific vehicle, said specific vehicles computer displays the interrupt condition on the dashboard indicator.
